(19) United States
(12) Patent Application Publication
(10) Pub. No.: US 2025/0163847 A1
(43) Pub. Date: May 22, 2025

(54) DUAL FUEL ENGINE SYSTEM

(71) Applicant: SHELL USA, INC., Houston, TX (US)

(72) Inventors: Roger Francis CRACKNELL, London (GB); Karim RASHIDMANESH, Waterloo (GB)

(21) Appl. No.: 18/842,383

(22) PCT Filed: Mar. 15, 2023
(86) PCT No.: PCT/EP2023/056564

§ 371 Date: Aug. 28, 2024

(30) Foreign Application Priority Data
Mar. 17, 2022 (EP) 22162833.2

(51) Int. Cl. F02B 69/04; F01N 3/10

(52) U.S. Cl. CPC F02B 69/04; F01N 3/103

(57) ABSTRACT

This invention provides a process for improving the sustainability of a dual-fuel engine system operated with a first liquid fuel and a second gaseous fuel, said process comprising providing to the engine system an EN15940 compliant paraffinic gasoil as the first liquid fuel and a gaseous fuel selected from ammonia, methanol, hydrogen and methane based gas as the second gaseous fuel, and combusting said fuels in an internal combustion engine system, wherein exhaust gases from combusting said fuels are contacted with a methane oxidation catalyst provided in the exhaust system of said internal combustion engine system.

### FIELD OF THE INVENTION

This invention relates to a method for improving the sustainability of a dual fuel engine system.

### BACKGROUND OF THE INVENTION

Natural gas, consisting mainly of methane, has a significant CO₂ advantage over crude oil-based fuels and burns more cleanly. Even higher CO₂ advantages are provided by methane from biogas production (biomethane) and from power-to-gas (power-to-methane) plants. This renewable methane production is attractive as it could be done with higher efficiency compared to other renewable fuel production pathways.

Methane (typically in the form of liquified natural gas—LNG) has been investigated as a fuel in applications such as heavy-duty trucks, inland waterway and sea going ships, locomotives, rockets, other heavy machinery, distributed island mode power generation and potentially in aircraft. However, the internal combustion engines and fuel systems used for these applications have traditionally been designed mostly for diesel-like fuels.

While pure methane provides a high mass-specific energy content (about 15% higher than gasoline and diesel), it is not easy to ignite without a bespoke and complex fuel injection system and therefore pure methane cannot easily be used in today's compression ignition engines used in energy efficient vehicles (trucks, ships, locomotives, and the like, as mentioned above). This is because self-ignition of methane happens at too high a temperature and the ignition delay times are too long.

So called ‘dual fuel’ engine systems have therefore been developed to allow existing or new heavy-duty engines to be operated with lower costs and/or lower emissions. Typically, a dual fuel engine is operated with a first liquid fuel in combination with a second gaseous fuel. The first liquid fuel is generally a self-ignitable fuel and the combustion ignition of that fuel is used to ignite the second gaseous fuel.

A number of methane-based dual fuel systems have been described in the prior art, including those in WO2017069120A1, US2016160791A1, WO2016052256A1, US2011259290A1, JP2007239600A2 and GB200601617A. Such dual-fuel engine systems have the potential to reduce costs and emissions, yet there still remains a number of issues to be overcome.

Methane, itself, is a greenhouse gas and any methane that is not completely combusted may be emitted from the dual-fuel engine system via the exhaust. The greater level of warming potential from methane compared to CO₂ may even negate the benefits of the CO₂ advantage obtained by using methane instead of crude oil-based fuels. Methane is also generally derived from natural gas, a fossil fuel, and the ignitable liquid fuels typically used in dual fuel systems are also typically fossil fuel derived.

Improved dual-fuel engine systems with better sustainability would, therefore, be a desirable goal.

### SUMMARY OF THE INVENTION

The present invention provides a process for improving the sustainability of a dual-fuel engine system operated with a first liquid fuel and a second gaseous fuel, said process comprising providing to the engine system an EN15940 compliant paraffinic gasoil as the first liquid fuel and a gaseous fuel selected from ammonia, methanol and methane based gas as the second gaseous fuel, and combusting said fuels in an internal combustion engine system, wherein exhaust gases from combusting said fuels are contacted with a methane oxidation catalyst provided in the exhaust system of said internal combustion engine system.

### BRIEF DESCRIPTION OF THE DRAWINGS

FIG. 1 is a schematic diagram illustrating a dual-fuel system of the type used in the present invention.

FIGS. 2 to 6 are graphs showing the results of the Examples.

### DETAILED DESCRIPTION OF THE INVENTION

An improved process for operating a dual-fuel engine system operated with a first liquid fuel and a second gaseous fuel has been determined. The use of a paraffinic gasoil as the first liquid fuel has been demonstrated to provide improved combustion efficiency (i.e., the extent to which the fuel is completely burned). The combination of specific fuel types with the use of a methane oxidation catalyst in the exhaust system of the dual-fuel engine system provides an even more effective way of reducing methane emissions.

The present process requires a paraffinic gasoil as the first liquid fuel. This liquid fuel is self-ignitable fuel, and the combustion ignition of that fuel is used to ignite the second gaseous fuel.

The operation of dual fuel engines is such that the ratio of the two fuels can be varied during operation. In general, it is possible to run the engine completely on the liquid fuel. This will be necessary under some circumstances to ensure compliance with emissions regulations, for example during a cold start. The invention presented here provides also provides a means to maximise the amount of gaseous fuel that can be used during the operation of the vehicle, whilst remaining compliant with emissions regulations. The use of the paraffinic fuel improves the completeness of the combustion, thereby reducing the amount to methane that is emitted from the engine without having been combusted. Moreover, the presence of a methane oxidation catalyst serves to oxidise any methane that has been emitted from the engine. The use of a dedicated methane oxidation catalyst, as opposed to a generic oxidation catalyst, recognises the particular challenges in oxidising methane.

The paraffinic gasoil is preferably selected from Fischer-Tropsch derived paraffinic gasoils, renewable paraffinic gasoils and mixtures thereof.

Renewable paraffinic gasoils are gasoils derived from a biological source or biomass through processes such as, but not limited to, hydrotreating, thermal conversion and biomass-to-liquids (BTL). A preferred renewable paraffinic gas oil is a hydrotreated vegetable oil (HVO) derived paraffinic gasoil.

The HVO process is based on an oil refining technology. In the process, hydrogen is used to remove oxygen from the triglyceride vegetable oil molecules and to split the triglyceride into three separate chains thus creating paraffinic hydrocarbons. HVO processes are described, for example in U.S. Ser. No. 10/941,349 and U.S. Pat. No. 8,809,610.

The paraffinic nature of gasoils derived from hydrotreated vegetable oils is very similar to Fischer-Tropsch derived gasoil.

By “Fischer-Tropsch derived” is meant that a fuel or base oil is, or derives from, a synthesis product of a Fischer-Tropsch condensation process. The term “non-Fischer-Tropsch derived” may be interpreted accordingly. A Fischer-Tropsch derived product may also be referred to as a GTL (gas-to-liquid) product. However, the term also covers biomass to liquid and power to liquid products.

The Fischer-Tropsch reaction converts carbon monoxide and hydrogen into longer chain, usually paraffinic, hydrocarbons:

n(CO+2H₂)═(—CH₂—)ₙ+nH₂O+heat

in the presence of an appropriate catalyst and typically at elevated temperatures (e.g. 125 to 300° C., preferably 175 to 250° C.) and/or pressures (e.g. 5 to 100 bar, preferably 12 to 50 bar). Hydrogen:carbon monoxide ratios other than 2:1 may be employed if desired.

The carbon monoxide and hydrogen may themselves be derived from organic or inorganic, natural or synthetic sources, typically either from natural gas or from organically derived methane. More recently techniques to derive carbon monoxide and hydrogen from other sources, including more sustainable ones are being explored and used. For example, starting with carbon dioxide and water, the water can be electrolysed to give free hydrogen, typically using electricity from a sustainable source. This hydrogen can react with the carbon dioxide in the ‘reverse water shift reaction’ to give a source of carbon monoxide. This carbon monoxide can then be reacted with the remaining hydrogen in the typical Fischer-Tropsch synthesis process. Because of the use of electrolysis, some of these production processes are referred to as ‘power-to-liquids’.

Gas oil, kerosene fuel and base oil products may be obtained directly from the Fischer-Tropsch reaction, or indirectly for instance by fractionation of Fischer-Tropsch synthesis products or from hydrotreated Fischer-Tropsch synthesis products. Hydrotreatment can involve hydrocracking to adjust the boiling range (see, e.g. GB2077289 and EP0147873) and/or hydroisomerisation which can improve cold flow properties by increasing the proportion of branched paraffins. EP0583836 describes a two-step hydrotreatment process in which a Fischer-Tropsch synthesis product is firstly subjected to hydroconversion under conditions such that it undergoes substantially no isomerisation or hydrocracking (this hydrogenates the olefinic and oxygen-containing components), and then at least part of the resultant product is hydroconverted under conditions such that hydrocracking and isomerisation occur to yield a substantially paraffinic hydrocarbon fuel or oil. Desired diesel fuel fraction(s) may subsequently be isolated for instance by distillation.

Other post-synthesis treatments, such as polymerisation, alkylation, distillation, cracking-decarboxylation, isomerisation and hydroreforming, may be employed to modify the properties of Fischer-Tropsch condensation products, as described for instance in U.S. Pat. Nos. 4,125,566 and 4,478,955.

Typical catalysts for the Fischer-Tropsch synthesis of paraffinic hydrocarbons comprise, as the catalytically active component, a metal from Group VIII of the periodic table, in particular ruthenium, iron, cobalt or nickel. Suitable such catalysts are described for instance in EP0583836.

An example of a Fischer-Tropsch based process is the SMDS (Shell Middle Distillate Synthesis) described in “The Shell Middle Distillate Synthesis Process”, van der Burgt, et al. (vide supra). This process (also sometimes referred to as the Shell “Gas-to-Liquids” or “GTL” technology) produces diesel range products by conversion of a natural gas (primarily methane) derived synthesis gas into a heavy long-chain hydrocarbon (paraffin) wax which can then be hydroconverted and fractionated to produce liquid transport and other fuels such as gasoils and kerosene. Versions of the SMDS process, utilising fixed-bed reactors for the catalytic conversion step, are currently in use in Bintulu, Malaysia, and in Pearl GTL, Ras Laffan, Qatar. Kerosenes and (gas)oils prepared by the SMDS process are commercially available for instance from the Shell Group of Companies.

By virtue of the Fischer-Tropsch process, a Fischer-Tropsch derived gasoil has essentially no, or undetectable levels of, sulphur and nitrogen. Compounds containing these heteroatoms tend to act as poisons for Fischer-Tropsch catalysts and are therefore removed from the synthesis gas feed. Further, the process as usually operated produces no or virtually no aromatic components.

Paraffinic gasoils, including Fischer-Tropsch derived paraffinic gasoils and renewable paraffinic gasoils, for use in the present invention must meet European EN 15940 specification.

The paraffinic gasoil will preferably consist of at least 95% w/w, more preferably at least 98% w/w, even more preferably at least 99.5% w/w, and most preferably up to 100% w/w of paraffinic components, preferably iso- and normal paraffins, preferably comprising from 80% w/w or greater of iso-paraffins.

The aromatics content of the paraffinic gasoil, as determined by ASTM D4629, will typically be below 1% w/w, preferably below 0.5% w/w and more preferably below 0.1% w/w.

Generally speaking, paraffinic gasoils have relatively low levels of polar components, in particular polar surfactants, for instance compared to petroleum derived fuels. It is believed that this can contribute to improved antifoaming and dehazing performance. Such polar components may include for example oxygenates, and sulphur and nitrogen containing compounds. A low level of sulphur in a Fischer-Tropsch derived fuel is generally indicative of low levels of both oxygenates and nitrogen-containing compounds since all are removed by the same treatment processes.

A preferred paraffinic gasoil for use herein has a distillation range similar to that of a petroleum derived diesel, that is typically within the 160° C. to 400° C. range, preferably with a T95 of 360° C. or less.

A preferred paraffinic gasoil for use herein will typically have a density (as measured by EN ISO 12185) of from 0.76 to 0.80, preferably from 0.77 to 0.79, more preferably from 0.775 to 0.785 g/cm³ at 15° C.

A preferred paraffinic gasoil for use herein has a cetane number (ASTM D613) of greater than 70, suitably from 70 to 85, most suitably from 70 to 77.

A preferred paraffinic gasoil for use herein has a kinematic viscosity at 40° C. (as measured according to ASTM D445) in the range from 2.0 mm²/s to 5.0 mm²/s, preferably from 2.5 mm²/s to 4.0 mm²/s.

A preferred paraffinic gasoil for use herein has a sulphur content (ASTM D2622) of 5 ppmw (parts per million by weight) or less, preferably of 2 ppmw or less.

The paraffinic gasoils used herein will preferably comprise no more than 3% w/w, more preferably no more than 2% w/w, even more preferably no more than 1% w/w of cycloparaffins (naphthenes), by weight of the paraffinic gasoils present.

The paraffinic gasoils used herein preferably comprise no more than 1% w/w, more preferably no more than 0.5% w/w, of olefins, by weight of the paraffinic gasoils present.

In a particularly preferred embodiment of the invention, the paraffinic gas oil comprises, or more preferably consists essentially of, one or more hydrotreated vegetable oil (HVO) derived paraffinic gasoils.

In the process of the present invention, the second gaseous fuel is selected from ammonia, methanol, hydrogen and a methane-based gas. It is preferred that the second gaseous fuel is a methane-based gas. As used herein the term ‘methane-based gas’ means a substance which is gaseous at ambient temperature and pressure, and which comprises a large proportion of methane. As used herein the term ‘ambient temperature and pressure’ means a temperature of 25° C. (298.15K) and a pressure of 1.01325 bar. As used herein the term ‘a large proportion of methane’ means a content of methane preferably greater than 70 vol %, more preferably greater than 80 vol %, and most preferably greater than 90 vol %, based on the total amount of methane-based gas.

The methane-based gas for use herein is preferably selected from natural gas, renewable methane gas, such as biomass-derived methane, synthetic methane from methanation processes, and mixtures thereof. In order to maximise the sustainability of the dual-fuel engine system, it is preferred that the methane-based gas is derived from a renewable process.

Methane-based gas may alternatively comprise mixtures of natural gas and hydrogen in any quantity in which natural gas is present at a level at which a methane oxidation catalyst is necessary to prevent methane emissions. The overall combined proportion of methane and hydrogen in the mixture means a content of methane/hydrogen combined preferably greater than 70 vol %, more preferably greater than 80 vol %, and most preferably greater than 90 vol %, based on the total amount of methane-based gas.

In the process of the present invention, the methane-based gas may be provided as a compressed gas, e.g., compressed natural gas (CNG), or a liquified gas, e.g., liquified natural gas (LNG).

In a particularly preferred embodiment of the present invention, both the first liquid fuel and the second gaseous fuel are produced from renewable resources. For example, in one embodiment, the first liquid fuel comprises an HVO-derived paraffinic gasoil and the second gaseous fuel comprises a biomass-derived methane.

Other additives may be added to either or both of the first liquid fuel or the second gaseous fuel or the combination thereof in order to improve the process of operating the dual-fuel engine system. Such additives would be well known to the person skilled in the art and include, but are not limited to, detergents, corrosion inhibitors, viscosity index improvers, anti-foam agents, dispersants, friction modifiers, odorisers, colourants and the like.

The combination of fuels is combusted in an internal combustion engine system. Such a combustion engine may be of a standard type that is used in road transport, marine, mining, rail and aircraft applications. Modifications may be made to the engine system to facilitate the use of dual-fuel.

Further improvements in the sustainability of a dual-fuel engine system are obtained in the present invention by the provision of a methane oxidation catalyst in the exhaust system of the internal combustion engine system. Such a catalyst may be any suitable catalyst capable of converting low levels of methane in exhaust gases to carbon dioxide and hydrogen. Such catalysts may be produced from noble metals and zirconia, for example according to US20190022625 or WO2018041630.

Typically, the exhaust gas handled by the exhaust system of the dual-fuel engine system contains a methane concentration of less than or equal to 10000 ppm by volume (ppmv), preferably in the range of from 25 ppmv to 10000 ppmv, more preferably of from 50 to 5000 ppmv and even more preferably from 100 to 3000 ppmv.

The methane in the exhaust gas is contacted with oxygen in the presence of the methane oxidation catalyst in order to convert said methane into carbon dioxide and water. Preferably, the methane and oxygen are contacted with the methane oxidation catalyst in a O₂:CH₄ ratio at least 2:1, more preferably at least 10:1, even more preferably at least 30:1, still even more preferably at least 50:1, yet more preferably at least 100:1. Preferably, the methane and oxygen are contacted with the methane oxidation catalyst in a O₂:CH₄ ratio of in the range of from 2:1 to 200:1, more preferably of from 10:1 to 200:1, even more preferably of from 30:1 to 200:1, still even more preferably of from 50:1 to 200:1, yet more preferably if from 100:1 to 200:1.

Preferably, the methane and oxygen are contacted with the methane oxidation catalyst at a temperature in the range of from 120 to 650° C., more preferably of from 250 to 650° C., still more preferably 300 to 600° C.

The oxygen used to oxidize the methane may be provided as part of the exhaust gas, and/or from an external source, such as air, oxygen enriched air, pure oxygen or mixtures of oxygen with one or more other, preferably inert, gases. Optionally, where part or all of the oxygen is provided from a source other than an exhaust gas it may be advantageous to preheat the oxygen prior to contacting the oxygen with the methane.

The combination of features provided by the present invention allows full advantage of the CO₂ advantage of using methane instead of crude oil-based fuels within standard internal combustion engines.

### DETAILED DESCRIPTION OF THE DRAWINGS

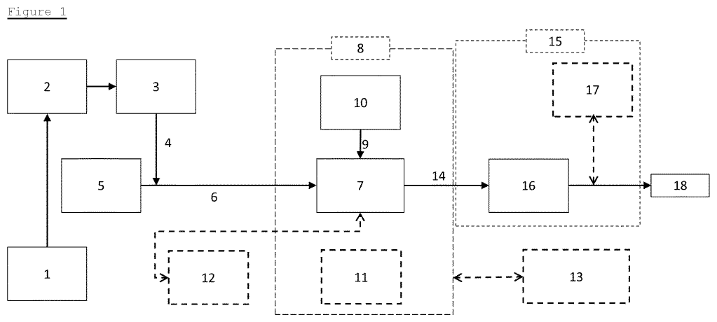

FIG. 1 provides a schematic illustration of a dual-fuel engine system operated by a process according to the present invention. The illustration is exemplary and not intended to limit the invention in any way.

Compressed natural gas (1) is provided via a pressure regulator (2) to a natural gas injector (3). The natural gas (4) is then injected into an air stream, which has been cleaned via an air filter (5), to form a natural gas/air mixture (6). The natural gas/air mixture (6) is then provided to the combustion chamber (7) of an engine (8), wherein it is mixed with a diesel stream (9) from a diesel injector (10). The engine (8) may also be fitted with an angle encoder (11), a combustion analyser (12) and a dynamometer (13) to track the combustion of the air/diesel/natural gas mixture and the action of the engine (8). Exhaust gases (14) from the combustion chamber (7) are then passed into an exhaust system (15). The exhaust system (15) contains a methane oxidation catalyst (16) and is typically fitted with an emissions analyser (17). The exhaust (18) of the system will contain very low levels of methane.

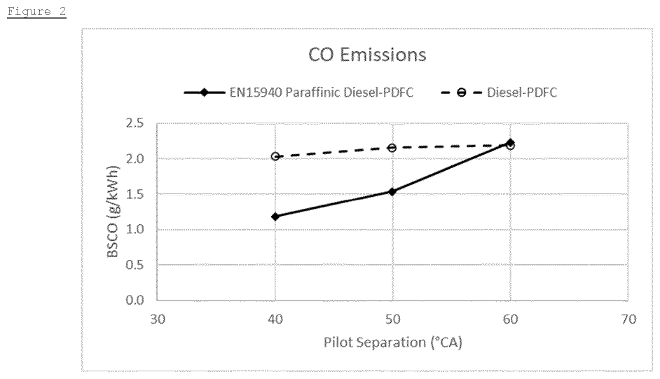

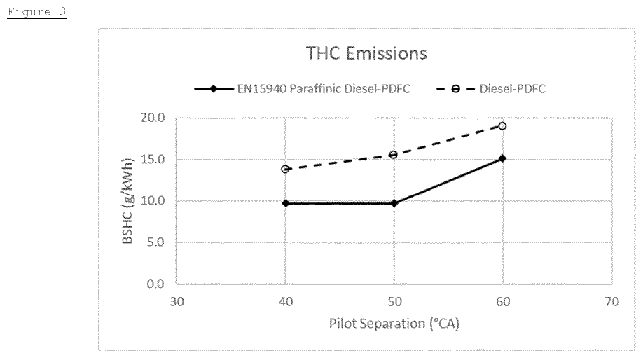

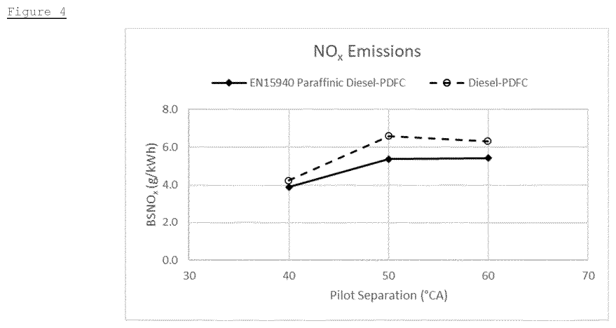

FIGS. 2 to 6 will be described in the following Examples.

The invention will now be further illustrated by reference to the following non-limiting examples.

### Examples

The Examples were performed using various fuel combinations of methane with diesel fuels. Both mineral diesel fuels and EN15940-compliant paraffinic diesel gasoils were tested. The test engine used was a model year 2010 Euro 5 four-cylinder 2.2 Litre Ford Puma diesel equipped with common rail direct fuel injection, a variable geometry turbocharger and cooled external Exhaust Gas Recirculation (EGR). Key specifications of the engine are provided in Table 1 below. The engine was equipped with gaseous port fuel injection and associated control.

TABLE 1
Engine specifications

| Car Brand/Type | Ford/Puma | |
|---|---|---|
| Swept volume | 2198 | cc |
| Bore | 86 | mm |
| Stroke | 94.6 | mm |
| Connecting rod | 155 | mm |
| length | | |
| Compression | 15.5:1 | |
| ratio | | |
| Firing order | 1-3-4-2 | |
| Injector | Piezoelectric/6 | |
| type/nozzle no. | holes | |
| Max. rail | 1800 | bar |

pressure

The test rig incorporated a DC dynamometer for controlling the speed and load and was accompanied by a standard industry set up for coolant fluid control and key measurements of torque, fuel consumption, engine performance and emissions.

Dual-fuel experimental work implemented Premixed Dual-Fuel Combustion (PDFC) with two pilot injections, with the first injection premixed prior to the second injection with a 50/50 ratio in quantity. The PDFC tests were undertaken at 1200 rpm/5.3 bar BMEP. Methane in 99.95% vol. was stored in gas bottles at 200 bar maximum pressure and supplied through the gaseous fuel delivery system, injected to the inlet of the intake manifold. The diesel rail pressure was kept fixed at 600 bar while the average pressure of the intake manifold was again held to 1.3 bar. The PDFC tests were undertaken under a 58% (±2) natural gas substitution ratio (by energy). The interval between the Start of Injection (SOI) of the pilot and main injections of the second pilot fuel was kept at −3° C. A ATDC (° Crank Angle After Top Dead Centre) and Start of Injection (SOI) of the first pilot was varied at 40, 50 and 60° C. A ahead. Table 2 shows the properties of the tested fuels used in the experimental

TABLE 2

| | | EN15940- | | |
|---|---|---|---|---|
| | | Compliant | | |
| | | Paraffinic | | |
| Property | ULSD | Gasoil | Methane | Gas Mix |
| Mixture | — | — | 99.95% | CH₄/C₂H₆ |
| | | | CH₄ | in 95/5 |
| | | | | % mole |
| Liquid | 820 | 779 | | |
| density at | | | | |
| 15° C. (kg/m3) | | | | |
| Gas density | | | 0.708 | 0.749 |
| at STP | | | | |
| (kg/m3) | | | | |
| LHV (MJ/kg) | 42.5 | 44 | 50 | 49.78 |
| Cetane Number | 45 | 79.5 | — | — |
| Max. Sulphur | 10 | 1 | — | — |
| (ppm-mass) | | | | |
| Auto-ignition | 250 | 207.2 | 807 | — |
| temperature | | | | |
| (° C.) | | | | |
| Carbon | 86.6 | 84.9 | 75 | 66.7 |
| content (% | | | | |
| mass) | | | | |
| Hydrogen | 13.4 | 15.1 | 25 | 33.3 |
| content (% | | | | |
| mass) | | | | |

To test the exhaust gas, samples were taken at the exhaust port after the turbine by two sampling probes, one for the gas analyser and another one for the smoke meter. Details of the gas analysers and smoke measuring devices are described in Table 3.

TABLE 3

| Gas | | | |
|---|---|---|---|
| Constituent | Equipment | Range | Accuracy |
| CO₂ | Signal 7000FM | 0 to 10% | <±1% of FS |
| | NDIR detector | | |
| CO | Signal 7000FM | 0 to 1% | <±1% of FS |
| | NDIR | | |
| NOₓ | Signal 4000VM | 0 to 3000 | <±1% of FS |
| | CLD | ppm | |
| O₂ | Signal 8000M | 0 to 25% | ±0.01% |
| | Paramagnetic | | |
| | detector | | |
| Intake CO₂ | Signal 7000FM | 0 to 10% | <±1% of FS |
| | NDIR | | |
| THC | Signal 3000HM | 0 to 3000 | <±1% of FS |
| | HFID | ppm C3 | |
| Smoke | AVL 415S Smoke | 0 to 10 FSN | 0.002 FSN or |
| | Meter | | 0.02 mg/mm3 |

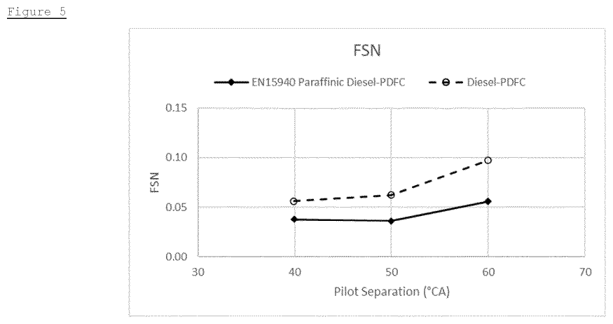

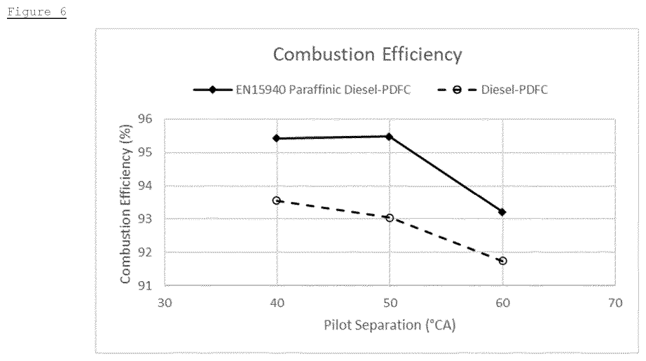

FIGS. 2 to 5 show the exhaust gas emissions during EN15940 paraffinic diesel-PDFC and diesel PDFC and FIG. 6 shows the combustion efficiency during EN15940 paraffinic diesel-PDFC and diesel PDFC tests. The x-axis of each of those Figures is labelled Pilot Separation and is measured in ° CA. EN15940 paraffinic diesel gasoil and diesel are referred to as pilot fuels. Pilot separation refers to the difference in ° CA between combustion of the pilot fuel and the combustion of the premixed gaseous fuel. The y-axes of FIGS. 2, 3 and 4 are labelled brake specific carbon monoxide (BSCO), brake specific hydrocarbon (BSHC) and brake specific oxides of nitrogen (BSNOₓ) respectively and are all measured in g/kWh. The y-axis of FIG. 5 is labelled as filter smoke number (FSN) and the y-axis of FIG. 6 is labelled as combustion efficiency and is measured in %.

FIGS. 2 to 5 show that using EN15940 paraffinic diesel as the pilot fuel generally results in lower emissions compared to using diesel. The lower CO and THC emissions for EN15940 paraffinic diesel-PDFC indicate a higher combustion efficiency compared to diesel-PDFC since there is less unburned CO and hydrocarbons. Those figures indicate that 40° C. A pilot separation is the optimum operating condition since it results to the lowest CO, THC, NOx and FSN values with both EN15940 paraffinic diesel and diesel as pilot fuels. Better fuel atomisation and entrainment of the injected pilot fuel within the premixed gaseous fuel provided more ignition sources for the surrounding gaseous fuel, thus improving flame propagation and the subsequent improvement in emissions and combustion efficiency.

FIG. 6 shows that using EN15940 paraffinic diesel gasoil as the pilot fuel results to higher combustion efficiency compared to using diesel.

This increase in combustion efficiency, when combined with a methane oxidation catalyst, results in considerable overall reductions in emissions and increased sustainability for a dual-fuel engine system. If such a system also uses bio-derived fuels, further sustainability improvements would be obtained.
1. A process for improving the sustainability of a dual-fuel engine system operated with a first liquid fuel and a second gaseous fuel, said process comprising providing to the engine system an EN15940 compliant paraffinic gasoil as the first liquid fuel and a gaseous fuel selected from ammonia, methanol and methane based gas as the second gaseous fuel, and combusting said fuels in an internal combustion engine system, wherein exhaust gases from combusting said fuels are contacted with a methane oxidation catalyst provided in the exhaust system of said internal combustion engine system.
2. A process as claimed in Claim 1, wherein said EN15940 compliant paraffinic gasoil comprises either a fossil derived Fischer-Tropsch derived paraffinic gasoil, a renewable paraffinic gasoil, or mixtures thereof.
3. A process as claimed in Claim 2, wherein the EN15940 compliant paraffinic gasoil comprises a hydrotreated vegetable oil derived paraffinic gasoil.
4. A process as claimed in Claim 3, wherein the EN15940 compliant paraffinic gasoil renewable paraffinic gasoil consists essentially of one or more hydrotreated vegetable oil derived paraffinic gasoils.
5. A process as claimed in and of Claims 1 to 4, wherein the second gaseous fuel is a methane based gas.
6. A process as claimed in Claim 5, wherein the methane based gas is provided by methane from biogas production or from a power-to-gas plant.
7. A process as claimed in any one of Claims 1 to 6, wherein the first liquid fuel comprises an hydrotreated vegetable oil derived paraffinic gasoil and the second gaseous fuel comprises a biomass-derived methane.
8. A process as claimed in any one of Claims 1 to 7, wherein the methane oxidation catalyst is produced from noble metals and zirconia.
9. A process as claimed in any one of Claims 1 to 8, wherein the exhaust gases are contacted with the methane oxidation catalyst such that methane present in the exhaust gases and oxygen are present in an O₂:CH₄ ratio of at least 2:1.
10. Use of one or more hydrotreated vegetable oil derived, EN15940-compliant paraffinic gasoils as a liquid fuel in a dual-fuel engine system, in which a methane based gas is used as a gaseous fuel, and in which, in the exhaust system of said engine system, a methane oxidation catalyst is provided, in order to reduce the emissions of methane from said engine system.

1. A process for improving the sustainability of a dual-fuel engine system operated with a first liquid fuel and a second gaseous fuel, said process comprising providing to the engine system an EN15940 compliant paraffinic gasoil as the first liquid fuel and a methane based gas as the second gaseous fuel, and combusting said fuels in an internal combustion engine system, wherein exhaust gases from combusting said fuels are contacted with a methane oxidation catalyst provided in the exhaust system of said internal combustion engine system, wherein the exhaust gases are contacted with the methane oxidation catalyst such that methane present in the exhaust gases and oxygen are present in an O₂:CH₄ ratio of at least 2:1.

2. A process as claimed in claim 1, wherein said EN15940 compliant paraffinic gasoil comprises a Fischer-Tropsch derived paraffinic gasoil, a renewable paraffinic gasoil, or mixtures thereof.

3. A process as claimed in claim 2, wherein the EN15940 compliant paraffinic gasoil comprises a hydrotreated vegetable oil derived paraffinic gasoil.

4. A process as claimed in claim 3, wherein the EN15940 compliant paraffinic gasoil consists essentially of one or more hydrotreated vegetable oil derived paraffinic gasoils.

5. A process as claimed in claim 1, wherein the methane based gas is provided by methane from biogas production or from a power-to-gas plant.

6. A process as claimed in claim 1, wherein the first liquid fuel comprises an hydrotreated vegetable oil derived paraffinic gasoil and the second gaseous fuel comprises a biomass-derived methane.

7. A process as claimed in claim 1, wherein the methane oxidation catalyst is produced from noble metals and zirconia.

8. A process for reducing the emissions of methane from an engine system, comprising providing one or more hydrotreated vegetable oil derived, EN15940-compliant paraffinic gasoils as a liquid fuel to a dual-fuel engine system, in which a methane based gas is used as a gaseous fuel, and providing a methane oxidation catalyst to an exhaust system of said engine system.
